(19) United States
(12) Patent Application Publication
(10) Pub. No.: US 2016/0030972 A1
(43) Pub. Date: Feb. 4, 2016

(54) CONTAINER ASSEMBLY FOR STORING AND DISPENSING A CHEMICAL ADHESIVE

(71) Applicant: Caterpillar Inc., Peoria, IL (US)

(72) Inventors: Lynsey G. Robertson, Ripley, MS (US); James C. Nanney, Booneville, MS (US); Jerone D. Woodruff, Burnsville, MS (US)

(73) Assignee: Caterpillar Inc., Peoria, IL (US)

(21) Appl. No.: 14/884,793

(22) Filed: Oct. 16, 2015

(51) Int. Cl. B05C 17/005

(52) U.S. Cl. CPC B05C 17/00583

(57) ABSTRACT

A container assembly for storing and dispensing a chemical adhesive is provided. The container assembly includes a bottom portion and an upper portion. The bottom portion contains the chemical adhesive. The upper portion is configured to be coupled and decoupled with the bottom portion. The upper portion includes a first section, a second section and a third section. The first section provides a grip for holding the upper portion of the container assembly. The first section includes impressions. The second section is adapted to couple and decouple the upper portion with the bottom portion. The third section has a foam applicator material positioned thereon. The foam applicator material is located at a distal end of the third section opposite the first section and extends around substantially all of a circumference of the third section.

### TECHNICAL FIELD

The present disclosure relates to adhesive's containers and more specifically to a container assembly for containing and dispensing a chemical adhesive.

### BACKGROUND

Chemical adhesives are utilized across various industries for a variety of purposes. Examples of chemical adhesives include, but are not limited to, Cyanoacrylates, Epoxy resins, polyester adhesives, among others. There are challenges for operators to store and manage the chemical adhesives in a day to day operation. The chemical adhesives are generally very sensitive to environmental factors, such as air, moisture, sunlight, among others.

There exist conventional containers for storing and applying the chemical adhesives. It is cumbersome for operators to safely and accurately apply the chemical adhesives to needed areas. Further, the operators may, in general, come in contact with the chemical adhesives during unpacking and further during applying of the chemical adhesives. The chemical adhesives may react with human skin and cause harmful damage to human tissues.

U.S. Published Application Number US2008/0234896 discloses a container suitable for dispensing moisture sensitive curable products, such as a Cyanoacrylates (CA) with a container body. The container body forms an internal reservoir for holding the product. The container body further includes a dispensing aperture. The container body is squeezable to allow easy dispensing of the product through the dispensing aperture. The container body regulates compressive force between front and rear walls. The dispensing force required is predictable and regular while a desired flexibility is achieved.

However, such containers fail to provide effective sealing to the chemical adhesive from contaminants Moreover, while applying the chemical adhesives using such container, there is a risk that the operators may come in contact with the chemical adhesive. Therefore, there is a need for a container assembly for storing and dispensing the chemical adhesives and further the container assembly is capable of dispensing the chemical adhesive to the needed areas while providing adequate protection to the operators.

### SUMMARY OF THE DISCLOSURE

In one aspect of the present disclosure, a container assembly for storing and dispensing a chemical adhesive is provided. The container assembly includes a bottom portion and an upper portion. The bottom portion contains the chemical adhesive. The upper portion is configured to be coupled and decoupled with the bottom portion. The upper portion includes a first section, a second section and a third section. The first section provides a grip for holding the upper portion of the container assembly, and also includes impressions. The second section is adapted to couple and decouple the upper portion with the bottom portion. The third section has a foam applicator material positioned thereon. The foam applicator material is located at a distal end of the third section opposite the first section and extends around substantially all of a circumference of the third section.

Other features and aspects of this disclosure will be apparent from the following description and the accompanying drawings.

### BRIEF DESCRIPTION OF THE DRAWINGS

FIG. 1 is a perspective view of a container assembly for storing and dispensing a chemical adhesive, according to the concepts of the present disclosure;

FIG. 2 is an exploded view of the container assembly of FIG. 1, according to the concepts of the present disclosure;

FIG. 3 is a perspective view of an upper portion of the container assembly of FIG. 1, according to the concepts of the present disclosure;

FIG. 4 is a perspective view of a bottom portion of the container assembly of FIG. 1, according to the concepts of the present disclosure; and

FIG. 5 depicts the upper portion of the container assembly of FIG. 1, while applying the chemical adhesive into a water seal bore, according to the concepts of the present disclosure.

### DETAILED DESCRIPTION

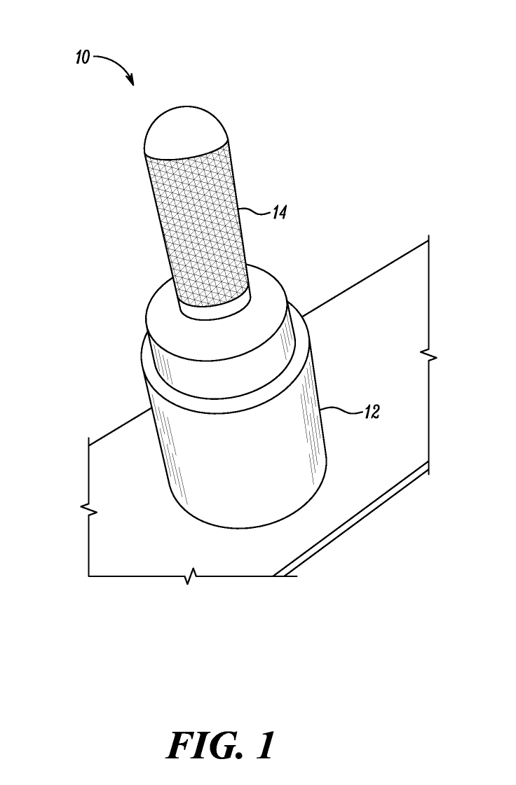

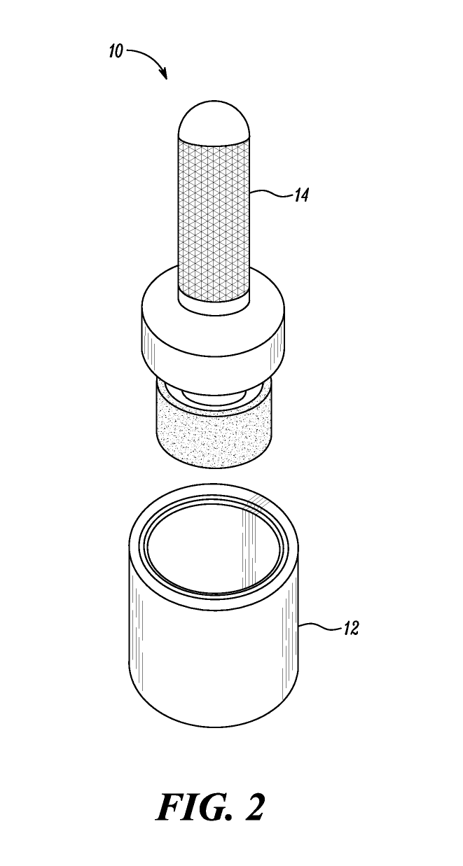

Referring to FIG. 1 and FIG. 2, a perspective view and an exploded view of a container assembly 10 is shown for storing and dispensing a chemical adhesive, according to the concepts of the present disclosure. The container assembly 10 is used for storing and applying the chemical adhesive to needed areas. The container assembly 10 includes a bottom portion 12 and an upper portion 14. The bottom portion 12 contains the chemical adhesive. The upper portion 14 is configured to be coupled and decoupled with the bottom portion 12. The upper portion 14 (also called a tooling) is used for applying the chemical adhesive to the needed areas, by decoupling from the bottom portion 12. On completion of dispensing of the chemical adhesive, the upper portion 14 is coupled back with the bottom portion 12. The shape and design of the bottom portion 12 of the container assembly 10 may vary. For example, the bottom portion 12 may have a cube shape, conical shape, frustum shape, or any other shape. Accordingly, the upper portion 14 is also designed so that the upper portion 14 can be easily and completely fitted-in with the bottom portion 12. The upper portion 14 and the bottom portion 12 are further described in detail in subsequent paragraphs.

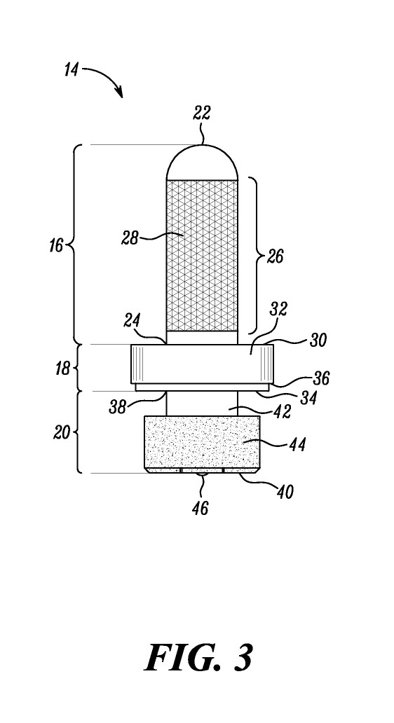

FIG. 3 is a side view of the upper portion 14 of the container assembly 10 of FIG. 1, according to the concepts of the present disclosure. The upper portion 14 includes a first section 16, a second section 18 and a third section 20. The first section 16 has a first end 22, a second end 24, and an intermediate portion 26. The first section 16 has a hemi-spherical shape at the first end 22. Further, the intermediate portion 26 has a cylindrical shape and provides a grip for holding the upper portion 14 of the container assembly 10. The first section 16 may also include impressions 28 on the outer wall of the intermediate portion 26. The impressions 28 provide sufficient grip for firmly holding the upper portion 14. Further, the impressions 28 facilitate in easy maneuvering of the upper portion 14 for applying the chemical adhesive to the needed area.

The upper portion 14 includes the second section 18. The second section 18 is a middle section between the first section 16 and the third section 20 of the container assembly 10. The second section 18 has a first end 30, a middle portion 32 and a second end 34. The second section 18 has a cylindrical shape (or drum-like shape) with a diameter larger than a diameter of the first section 16 and the third section 20. The second section 18 is adapted to couple and decouple the upper portion 14 with the bottom portion 12 of the container assembly 10, using a first coupling portion 36. In an embodiment of the present disclosure, the second section 18 is coupled and decoupled with the bottom portion 12 using various coupling mechanisms including, but not limited to, threads, fit-in mechanisms, or any other mechanism without departing from the scope of the present disclosure.

The upper portion 14 further includes the third section 20. The third section 20 has a proximal end 38, a distal end 40 and middle portion 42. The proximal end 38 of the third section 20 is in contact with the second end 34 of the second section 18 of the upper portion 14. The third section 20 has a foam applicator material 44 positioned thereon. The foam applicator material 44 is located at a distal end 40 of the third section 20 opposite to the first section 16. The foam applicator material 44 extends around substantially all of a circumference of the third section 20, extending from the middle portion 42 towards the distal end 40 of the third section 20. In other words, the foam applicator material 44 is wrapped around the outer periphery of the middle portion 42 and extending towards the distal end 40 of the third section 20. In an embodiment, the foam applicator material 44 uses a 1 inch foam weep hole plug which facilitates in smooth dispensing of the chemical adhesive to the needed areas. The third section 20 may also use other suitable materials other than the foam applicator material 44 for dispensing the chemical adhesive. Also, the foam applicator material 44 can be extended around the third section 20 in any other orientation, design and configuration that facilitates smooth and efficient dispensing of the chemical adhesive without departing from the scope of the present disclosure. The foam applicator material 44 that extends around substantially all of the circumference extending from the middle portion 42 towards the distal end 40 is attached to the third section 20 using a screw 46, such as but not limited to, a drill and tap for ¼-20 pan head screw. It will be apparent to one skilled in art that the foam applicator material 44 may be attached around the circumference extending from the middle portion 42 towards the distal end 40 of the third section 20 using other attachment mechanisms other than the screw 46 without departing from the scope of the present disclosure.

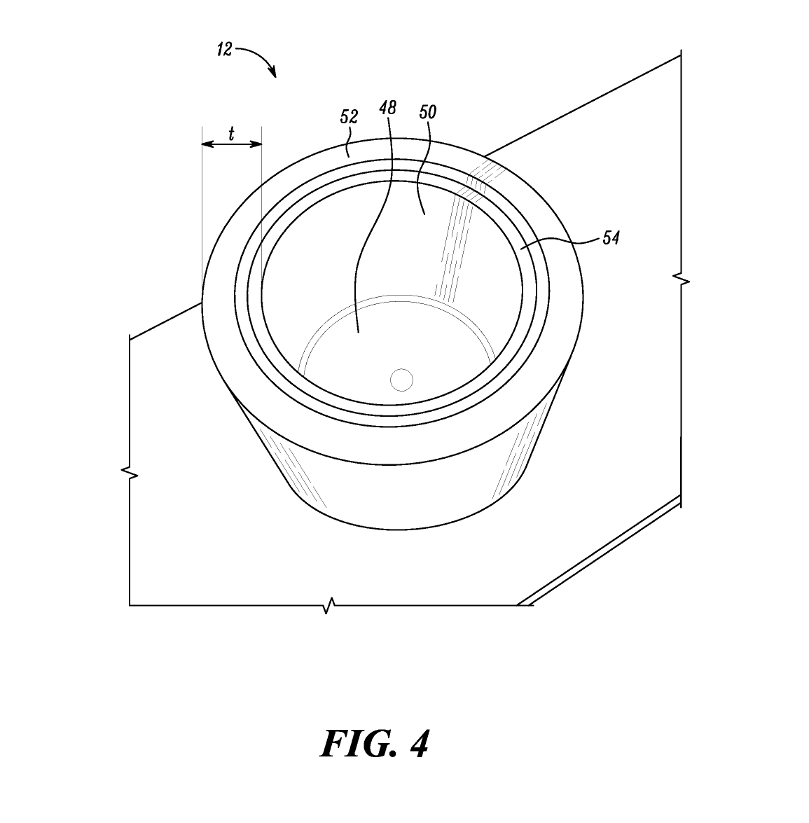

FIG. 4 is a perspective view of the bottom portion 12 of the container assembly 10 of FIG. 1, according to the concepts of the present disclosure. The bottom portion 12 of the container assembly 10 includes a bottom part 48, a middle part 50 and a top part 52. The bottom portion 12 has a thickness “t’ as shown in FIG. 4. In coupled configuration, the bottom portion 12 of the container assembly 10 houses the third section 20 of the upper portion 14 of the container assembly 10 (as illustrated in coupled configuration of FIG. 1). More specifically, in the coupled configuration, the middle portion 50 of the bottom portion 12 houses the third section 20 along with the foam applicator material 44 of the upper portion 14 of the container assembly 10. The middle part 50 has a hollow cylinder shape that forms a cavity for containing the chemical adhesive. It will be apparent to one skilled in art that the bottom portion 12 may have any other shape, size or thickness for suitably containing the chemical adhesive without departing from the scope of the present disclosure. The bottom portion 12 includes a second coupling portion 54. The first coupling portion 36 (of FIG. 3) and the second coupling portion 54 correspond to each other and facilitate coupling and decoupling of the upper portion 14 with the bottom portion 12 of the container assembly 10. Each of the first coupling portion 36 and the second coupling portion 54 includes a step like structure, which is used to enable the coupling. It will be apparent to one skilled in art that a variety of other known techniques for coupling may be used such as, but not limited to, such as a lock-in mechanism, threads, or any other fit-in mechanism for coupling and/or decoupling of the upper portion 14 with the bottom portion 12 of the container assembly 100.

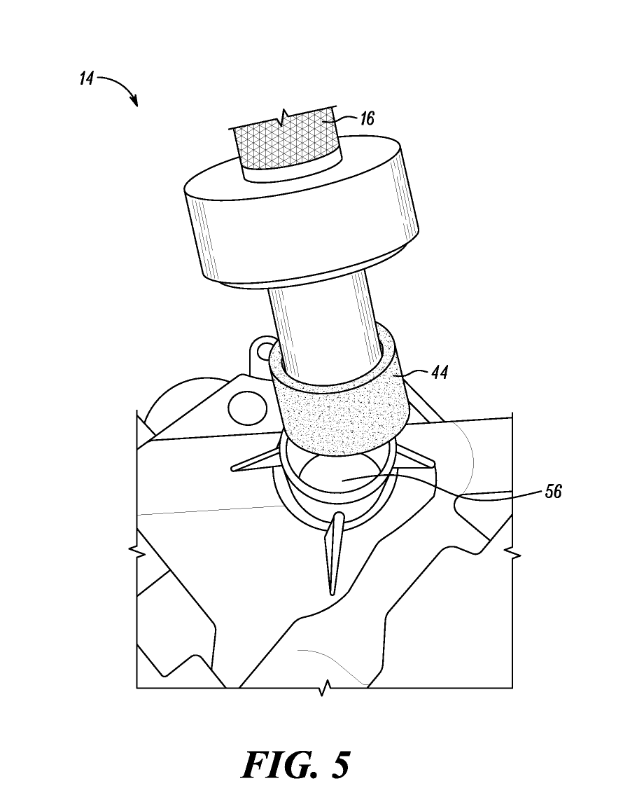

FIG. 5 depicts the upper portion 14 of the container assembly 10 of FIG. 1, while applying the chemical adhesive into a water seal bore 56, according to the concepts of the present disclosure. In order to apply the chemical adhesive, the upper portion 14 is first decoupled from the bottom portion 12 of the container assembly 10 (as shown in exploded view in FIG. 2). An operator holds the upper portion 14 with the help of the first section 16 and applies the chemical adhesive into the water seal bore 56 via the foam applicator material 44 (as shown in FIG. 3). In other words, the operator holds the first section 16 to maneuver the foam applicator material 44 over the water seal bore 56 and smoothly applying the chemical adhesive. The chemical adhesive may include, but is not limited to, Cyanoacrylate (CA), Epoxy resin, polyester adhesive, among others. It will be apparent to one skilled in art that the chemical adhesive may include other known chemicals having similar properties. Further, the shape, design and properties of the foam applicator material 44 is such that the operator can easily apply the chemical adhesive to complex cavities, geometric shapes/regions where it is otherwise difficult to apply.

Further, the bottom portion 12 and the upper portion 14 are made of materials including, but not limited to, Nylon, Ultra-High-Molecular-Weight Polyethylene (UHMWPE, UHMW), high-modulus polyethylene (HMPE), high-performance polyethylene (HPPE), among others without departing from the scope of the present disclosure.

### INDUSTRIAL APPLICABILITY

While using conventional containers, it generally becomes difficult for the operator to safely and accurately apply the chemical adhesive to the needed areas. There are various areas, such as complex cavities, geometric shapes/regions, among others wherein it becomes extremely difficult for the operator to uniformly and accurately apply the chemical adhesive with the help of conventional containers. While using conventional containers, there is a chance that the operator may come in contact with the chemical adhesive during unpacking a chemical adhesive and further during applying of the chemical adhesive. Also, there are chances of undesirable spilling of the chemical adhesive over shop floor, or over delicate instruments. Further, the conventional containers are unable to provide sufficient contamination protection from various environmental factors, such as air, moisture, sunlight, among others. All such factors lead to wastage of expensive chemical adhesive.

The present disclosure provides the container assembly 10 for storing and dispensing the chemical adhesive. The container assembly 10 prevents contamination of the chemical adhesive and therefore eliminates the wastage of expensive chemical adhesives. The first section 16 provides a grip for holding the upper portion 14 of the container assembly 10, which a user (also called an operator) can easily hold for applying the chemical adhesives to the needed areas via the foam applicator material 44. The design of the upper portion 14 makes it easy for the user to uniformly and accurately apply the chemical adhesive to complex cavities, and geometric shapes/regions. Also, the container assembly 10 prevents the user from coming in contact with the chemical adhesive during application, thereby, improving the safety. Moreover, the material of construction of the bottom portion 12 and the upper portion 14 includes, but is not limited to, Nylon, Ultra-High-Molecular-Weight Polyethylene (UHMWPE, UHMW), high-modulus polyethylene (HMPE), high-performance polyethylene (HPPE), among others. Such materials provide sufficient strength and durability to the container assembly 10 such that the container assembly 10 is not compressed during day to day operations, such as handling, transportation.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A container assembly for storing and dispensing a chemical adhesive comprising:
a bottom portion containing the chemical adhesive; and
an upper portion configured to be coupled and decoupled with the bottom portion, the upper portion including:
a first section for providing a grip for holding the upper portion of the container assembly, the first section having impressions;
a second section adapted to couple and decouple the upper portion with the bottom portion; and
a third section having a foam applicator material positioned thereon, the foam applicator material being located at a distal end of the third section opposite the first section and extending around substantially all of a circumference of the third section.
